(19) United States
(12) Patent Application Publication
(10) Pub. No.: US 2018/0279228 A1
(43) Pub. Date: Sep. 27, 2018

(54) Uplink Power Control in Heterogeneous Network Scenarios

(71) Applicant: Nokia Solutions and Networks Oy, Espoo (FI)

(72) Inventors: Ingo VIERING, Munich (DE); Berhard WEGMANN, Holzkirchen (DE); Henrik MARTIKAINEN, Jyvaskyla (FI)

(21) Appl. No.: 15/763,477

(22) PCT Filed: Oct. 1, 2015
(86) PCT No.: PCT/EP2015/072702

§ 371 Date: Mar. 27, 2018

(51) Int. Cl. H04W 52/14; H04W 52/10; H04W 52/24; H04W 52/36

(52) U.S. Cl. CPC H04W 52/146; H04W 52/10; H04W 52/367; H04W 52/242; H04W 52/244

(57) ABSTRACT

There are provided measures for uplink power control in heterogeneous network scenarios. Such measures exemplarily comprise include obtaining an upper limit value for a network configuration parameter, determining said network configuration parameter for said first cell on the basis of performance data of said first cell and said upper limit value such that said network configuration parameter does not exceed said upper limit value, and signaling said network configuration parameter for said first cell.

### FIELD

The present invention relates to uplink power control in heterogeneous network scenarios. More specifically, the present invention exemplarily relates to measures (including methods, apparatuses and computer program products) for realizing uplink power control in heterogeneous network scenarios.

### BACKGROUND

The present specification generally relates to mobile radio communications with focus on self optimizing networks (SON) for automated setting/configuration of uplink (UL) open loop power control (OLPC) parameter setting.

The OLPC is responsible for the basic setting of a user equipment (UE) transmit power (P_{UE}_{_}_{TXP}) which compensates path-loss (including shadowing) in order to achieve almost the same received signal power for all UEs within a single cell that fulfills dynamic range requirements. In this way, e.g. the well-known near-far-effect can be tackled or is at least treated.

The single-cell power control formula in 3^{rd} Generation Partnership Project (3GPP) Long Term Evolution (LTE) is given by,

P_{UE}_{_}_{TXP}=min{Pₘₐₓ,10·log,₁₀(M)+P₀α·PL_{DL}+Δ_{MCS}+δ} (1)

where the parameters P₀ and α (namely the base level P₀ and the path-loss compensation factor α) are to be adjusted cell-specifically.

In formula (1), the latter part Δ_{MCS}+δ represents the “closed loop” part of the power control, since those values are regularly corrected in a user-specific way by an evolved NodeB (eNodeB, eNB).

Further, in formula (1), the former part is typically called “open loop” since the values P₀ and α are typically broadcasted by the eNB (actually, radio resource control (RRC) signaling is used, but the same parameters are sent to every UE of a cell served by the eNB).

For homogeneous macro-only deployments, the P₀ and α can be configured such that on one side the dynamic range of received UL power at the base station antenna port is kept within allowed limits, and on the other side that UEs are not driven into unnecessary power limitation. Within those limits, a larger P₀ will always increase the signal to interference and noise ratio (SINR), and thereby always decreases the UL throughput of the terminals (e.g. UEs) in the cell (provided that neighboring cells are not affected).

Experiments (results of experiments) have shown that a simple and egoistic automatic adaptation of P₀ (only based on dynamic range and power headrooms) leads to very good results in macro-only networks, in comparison to previously known, more complicated approaches looking at load and produced interference instead of dynamic range.

In heterogeneous networks (HetNet), however, where pico cells with lower power nodes are placed within the macro cell coverage (pico cell encompassed by macro cell) at places where traffic concentration is expected, the situation is different.

Namely, the pico cells build a second layer and are overlaying with the macro cells. Therefore, in case of co-channel deployment, a mutual interference of the overlaying pico cells with the macro cells requires a different configuration of the OLPC parameters.

For UL transmissions in heterogeneous networks with pico cells inside macro cells, there are basically the following two critical mutual interference scenarios in uplink transmission.

FIG. 7 is a schematic diagram illustrating these exemplary scenarios and in particular mutual interference issues for/in HetNet deployments.

Namely, in a first scenario, a pico cell (served by the right pico eNB) is at an edge of the macro cell, and the macro-UEs (M-UEs) near the pico cell transmit with high power to overcome high path loss (path-loss) towards the serving macro-eNB and generate rather high UL interference at the pico cells.

Further, in a second scenario, for pico cells (served by the left pico eNB) located close to a macro-eNB, the pico-UEs (P-UEs) may become a serious threat of interference to the M-UEs because a received signal from far UEs (received at the macro-eNB) is rather low and UL power control (PC) tries to keep all UEs in this range.

Irrespective whether the OLPC parameters are configured/optimized automatically (by means of SON) or manually by network planning experts, for HetNet deployments, more advanced rules for the setting of the OLPC parameters of the overlayed pico cells is needed. In particular, the aforementioned simple and egoistic method may degrade the macro cells over-proportionally by too large pico interference.

Namely, an automated cell-specific OLPC parameter configuration/optimization algorithm for single layer cellular deployment only consisting of adjacent cells tries to maximize P₀, since a large P₀ normally provides a better SINR, and in turn provides a higher UL throughput of the terminal in the cell.

However, in case of a HetNet deployment/scenario, the same cell-specific approach which is only based on cell-internal properties derived from e.g. dynamic range and power headroom (PHR) statistics would optimize the small cells on expense of macro cell performance degradation.

FIG. 8 is a schematic diagram illustrating UL power from different UEs received at various base stations.

In particular, an exemplary disadvantageous situation is illustrated, in which a configured transmission (TX) power of P-UE 1 is suitable for reception at P-eNB (pico base station, picoBS (PBS)) A, while the TX power of P-UE 1 significantly interferes the TX power of M-UE to be received at the M-eNB (macro base station, macroBS (MBS)). As can be seen in FIG. 8, a P₀ optimization for P-UE 1 leads to too high UL TX power of P-UE 1 which heavily drowns the received signal from macro UEs (e.g. M-UE) at the macro base station.

Since macro and pico cell are having different path loss (path-loss, PL) ranges (cell sizes), the range of UL received power at the base station is different and the resulting UL interference issues coming along with co-channel HetNet deployments are well known. Accordingly, there are some approaches regarding these issues known.

Namely, for a UE that can be connected simultaneously with both macro and small (pico) cell, for instance a power control is provided, where a virtual UE path loss among the two connections is considered and where finding and configuring appropriate setting is done by a closed loop.

Further, the necessity and the benefits of automated OLPC parameter setting in HetNet deployment has been discussed. According to such discussion, a heuristic linear equation P₀=A* PL_{M-P}+B is proposed, where a cell-specific P₀ value of the small cell is derived from the downlink path loss of the covering co-channel macro cell node to the small cell node in question. However, such approach requires two new parameters A and B for determining another one, which implies increased effort on the operator's and hardware side. Namely, the more parameters are present, the more parameters need to be maintained and optimized under consideration of potential side effects on other parameters. Further, this approach does neither consider the weakest receiving UL signal in the macro cell nor try to maximize the P₀ first for best small cell UL performance. Finally, the used parameters are defined by parameter sweep and for one specific simulation scenario. Such an approach might be usable in network planning phase, but is not practicable in a real on-line cell-specific automated configuration and optimization.

According to a further approach (equal UL power spectral density (PSD) approach), the small cell P₀ is adjusted such that the UL power density of the M-UE and P-UE at the cell border are equal. This criterion should guarantee that the receiving signals at the corresponding base stations are also equal. This approach, again, does not maximize the P₀ of the small cell first and further does not take the received macro UL signal from the farthest M-UE into account.

Hence, the problem arises that for the case of HetNet deployments/scenarios, the automated OLPC optimization algorithm (and further known approaches) need to be extended such that the mutual inter-relationship of the macro and pico layer is taken into account. In particular, an independent P₀ optimization in pico cell leads to too high UL TX power of P-UE which heavily drowns the received signal from macro UEs at the macro base station.

Hence, there is a need to provide for uplink power control in heterogeneous network scenarios.

### SUMMARY

Various exemplary embodiments of the present invention aim at addressing at least part of the above issues and/or problems and drawbacks.

Various aspects of exemplary embodiments of the present invention are set out in the appended claims.

According to an exemplary aspect of the present invention, there is provided a method in a first cell encompassed by a second cell in a heterogeneous network scenario, the method comprising obtaining an upper limit value for a network configuration parameter, determining said network configuration parameter for said first cell on the basis of performance data of said first cell and said upper limit value such that said network configuration parameter does not exceed said upper limit value, and signaling said network configuration parameter for said first cell.

According to an exemplary aspect of the present invention, there is provided a method in a second cell encompassing a first cell in a heterogeneous network scenario, the method comprising determining properties of said second cell, and assisting determination of a network configuration parameter for said first cell by an obtained upper limit value for said network configuration parameter on the basis of said properties of said second cell.

According to an exemplary aspect of the present invention, there is provided an apparatus in a first cell encompassed by a second cell in a heterogeneous network scenario, the apparatus comprising at least one processor, at least one memory including computer program code, and at least one interface configured for communication with at least another apparatus, the at least one processor, with the at least one memory and the computer program code, being configured to cause the apparatus to perform obtaining an upper limit value for a network configuration parameter, determining said network configuration parameter for said first cell on the basis of performance data of said first cell and said upper limit value such that said network configuration parameter does not exceed said upper limit value, and signaling said network configuration parameter for said first cell.

According to an exemplary aspect of the present invention, there is provided an apparatus in a first cell encompassed by a second cell in a heterogeneous network scenario, the apparatus comprising at least one processor, at least one memory including computer program code, and at least one interface configured for communication with at least another apparatus, the at least one processor, with the at least one memory and the computer program code, being configured to cause the apparatus to perform determining properties of said second cell, and assisting determination of a network configuration parameter for said first cell by an obtained upper limit value for said network configuration parameter on the basis of said properties of said second cell. According to an exemplary aspect of the present invention, there is provided an apparatus in a first cell encompassed by a second cell in a heterogeneous network scenario, the apparatus comprising obtaining circuitry configured to obtain an upper limit value for a network configuration parameter, determining circuitry configured to determine said network configuration parameter for said first cell on the basis of performance data of said first cell and said upper limit value such that said network configuration parameter does not exceed said upper limit value, and signaling circuitry configured to signal said network configuration parameter for said first cell.

According to an exemplary aspect of the present invention, there is provided an apparatus in a first cell encompassed by a second cell in a heterogeneous network scenario, the apparatus comprising determining circuitry configured to determine properties of said second cell, and assisting circuitry configured to assist determination of a network configuration parameter for said first cell by an obtained upper limit value for said network configuration parameter on the basis of said properties of said second cell.

According to an exemplary aspect of the present invention, there is provided a system in a heterogeneous network scenario, comprising an apparatus according to any one of the aforementioned apparatus-related exemplary aspects of the present invention in a first cell, and an apparatus according to any one of the aforementioned apparatus-related exemplary aspects of the present invention in a second cell encompassing said first cell.

According to an exemplary aspect of the present invention, there is provided a computer program product comprising computer-executable computer program code which, when the program is run on a computer (e.g. a computer of an apparatus according to any one of the aforementioned apparatus-related exemplary aspects of the present invention), is configured to cause the computer to carry out the method according to any one of the aforementioned method-related exemplary aspects of the present invention.

Such computer program product may comprise (or be embodied) a (tangible) computer-readable (storage) medium or the like on which the computer-executable computer program code is stored, and/or the program may be directly loadable into an internal memory of the computer or a processor thereof.

Any one of the above aspects enables an efficient optimization and optimal balancing of the small (pico) cell UE throughput without harming the macro UL throughput to thereby solve at least part of the problems and drawbacks identified in relation to the prior art.

By way of exemplary embodiments of the present invention, there is provided uplink power control in heterogeneous network scenarios. More specifically, by way of exemplary embodiments of the present invention, there are provided measures and mechanisms for realizing uplink power control in heterogeneous network scenarios.

Thus, improvement is achieved by methods, apparatuses and computer program products enabling/realizing uplink power control in heterogeneous network scenarios.

### BRIEF DESCRIPTION OF THE DRAWINGS

In the following, the present invention will be described in greater detail by way of non-limiting examples with reference to the accompanying drawings, in which

FIG. 1 is a block diagram illustrating an apparatus according to exemplary embodiments of the present invention,

FIG. 2 is a block diagram illustrating an apparatus according to exemplary embodiments of the present invention,

FIG. 3 is a block diagram illustrating an apparatus according to exemplary embodiments of the present invention,

FIG. 4 is a block diagram illustrating an apparatus according to exemplary embodiments of the present invention,

FIG. 5 is a schematic diagram of a procedure according to exemplary embodiments of the present invention,

FIG. 6 is a schematic diagram of a procedure according to exemplary embodiments of the present invention,

FIG. 7 is a schematic diagram illustrating mutual interference issues in exemplary HetNet scenarios,

FIG. 8 is a schematic diagram illustrating UL power from different UEs received at various base stations,

FIG. 9 is a schematic diagram illustrating an exemplary HetNet deployment with small cells and five different hot spot configurations within the cell area,

FIG. 10 shows diagrams illustrating simulation results for the exemplary HetNet deployment of FIG. 9,

FIG. 11 is a schematic diagram illustrating UL power from different UEs received at various base stations according to exemplary embodiments of the present invention,

FIG. 12 is a schematic diagram illustrating determination of cell specific parameters,

FIG. 13 shows diagrams illustrating simulation results for the exemplary HetNet deployment of FIG. 9 including results according to exemplary embodiments of the present invention, and

FIG. 14 is a block diagram alternatively illustrating apparatuses according to exemplary embodiments of the present invention.

### DETAILED DESCRIPTION OF DRAWINGS AND EMBODIMENTS OF THE PRESENT INVENTION

The present invention is described herein with reference to particular non-limiting examples and to what are presently considered to be conceivable embodiments of the present invention. A person skilled in the art will appreciate that the invention is by no means limited to these examples, and may be more broadly applied.

It is to be noted that the following description of the present invention and its embodiments mainly refers to specifications being used as non-limiting examples for certain exemplary network configurations and deployments. Namely, the present invention and its embodiments are mainly described in relation to 3GPP specifications being used as non-limiting examples for certain exemplary network configurations and deployments. In particular, a HetNet scenario including a first cell (e.g. pico cell) encompassed/covered by a second cell (e.g. macro cell) is used as a non-limiting example for the applicability of thus described exemplary embodiments. As such, the description of exemplary embodiments given herein specifically refers to terminology which is directly related thereto. Such terminology is only used in the context of the presented non-limiting examples, and does naturally not limit the invention in any way. Rather, any other communication or communication related system deployment, etc. may also be utilized as long as compliant with the features described herein.

Hereinafter, various embodiments and implementations of the present invention and its aspects or embodiments are described using several variants and/or alternatives. It is generally noted that, according to certain needs and constraints, all of the described variants and/or alternatives may be provided alone or in any conceivable combination (also including combinations of individual features of the various variants and/or alternatives).

According to exemplary embodiments of the present invention, in general terms, there are provided measures and mechanisms for (enabling/realizing) uplink power control in heterogeneous network scenarios.

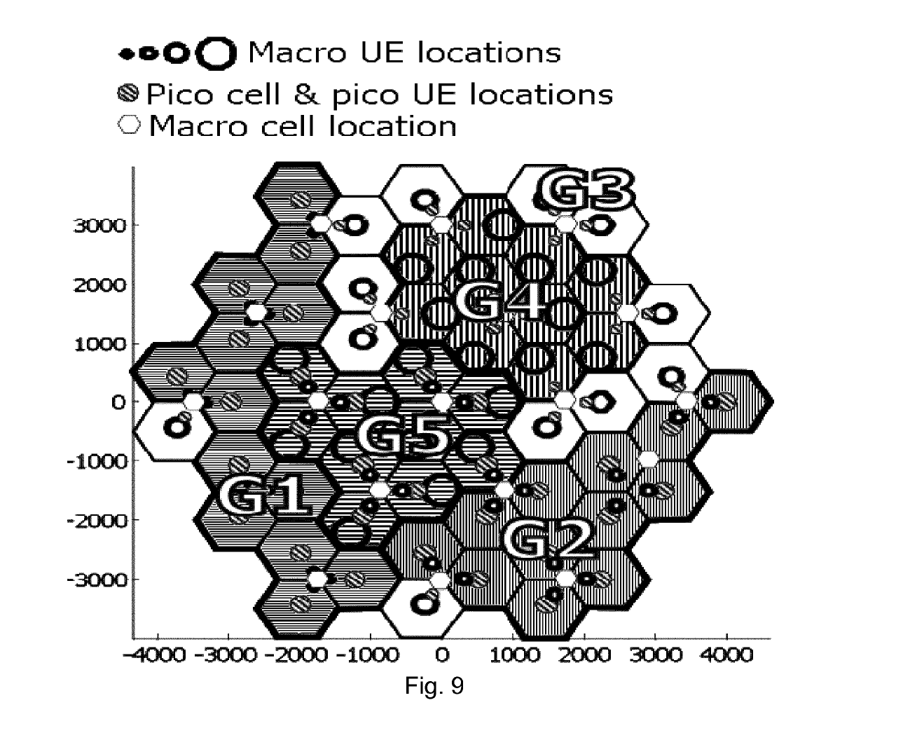

FIG. 9 is a schematic diagram illustrating an exemplary HetNet deployment with small cells and five different hot spot configurations within the cell area.

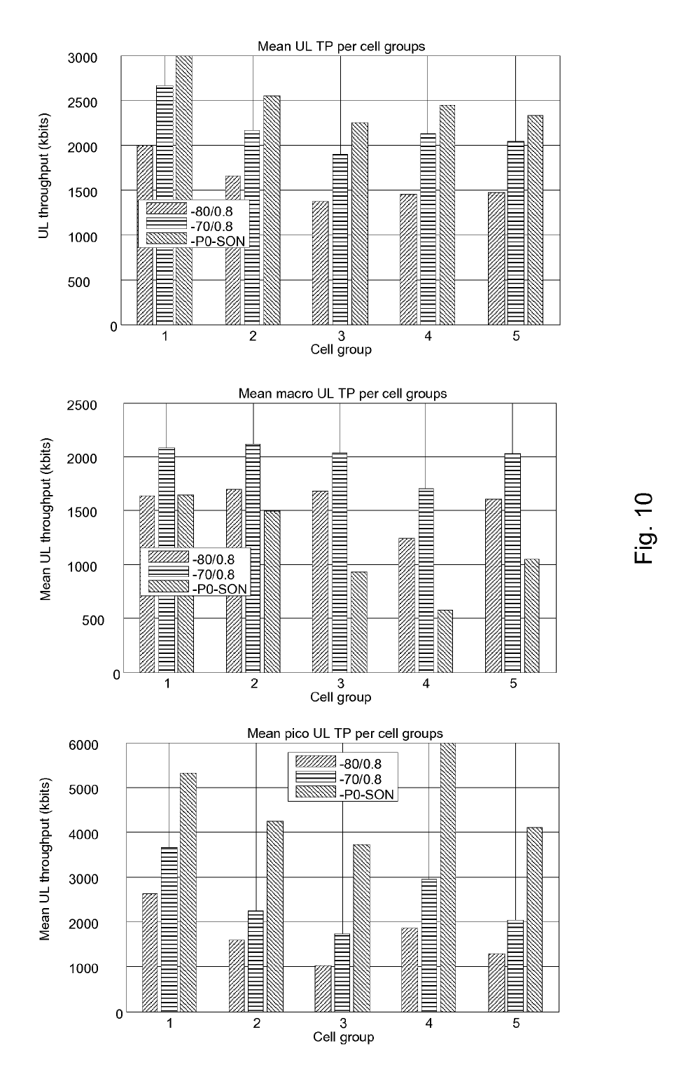

Further, FIG. 10 shows diagrams illustrating simulation results for the exemplary HetNet deployment of FIG. 9. The simulative analysis according to these Figures has shown macro UL performance degradation if the UL OLPC parameters are configured/optimized cell-individually (P0-SON algorithm) without mutual assistance from the layer. FIG. 10 shows the average user throughput for different cell groups (G1-G5) in HetNet deployment (see FIG. 9) given by specific traffic hot spot placement.

As can be seen in FIG. 10, the P0-SON algorithm where P₀ is cell-individually optimized improves the average UE throughput for all UEs (upper diagram in FIG. 10) compared to a network-wide fixed setting (80/0.8; 70/0.8) and in particular heavily improves the P-UEs throughput (lower diagram in FIG. 10) on expense of degrading the throughput of the M-UEs (middle diagram in FIG. 10).

The individual cell-specific P₀ optimization maximizes the P₀ values of the cell, observing cell-individual limitations such as dynamic range or power limitation of UEs. This maximizes the performance of the users in the own cell. This is optimal as long as the two layers are operating interference-free (e.g. on two different frequencies).

However, in case of co-channel operation, as a general idea according to exemplary embodiments of the present invention, the parameter P₀ determining the base level of the UE transmit power control needs to be limited such that there is no or rather minimal degradation of M-UEs. Furthermore, the P₀ limitation which is applied for the small cells must ensure a proper reception of the farthest M-UE.

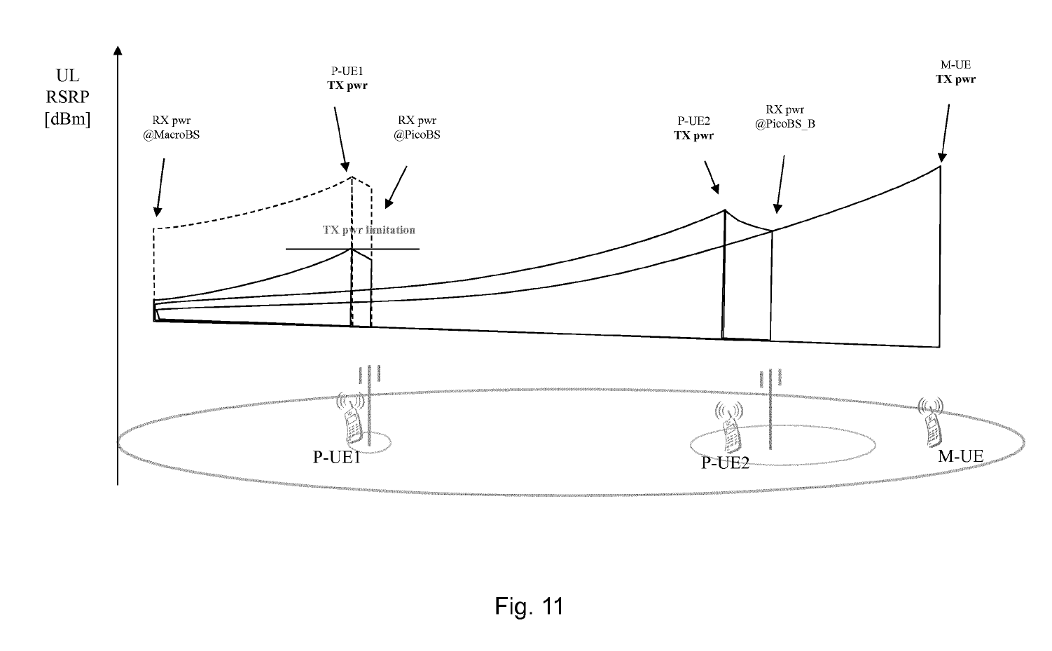

FIG. 11 is a schematic diagram illustrating UL power from different UEs received at various base stations according to exemplary embodiments of the present invention and in particular shows the P₀ limitation applied for the small cell PicoBS and the result thereof (reduced P-UE 1 TX power).

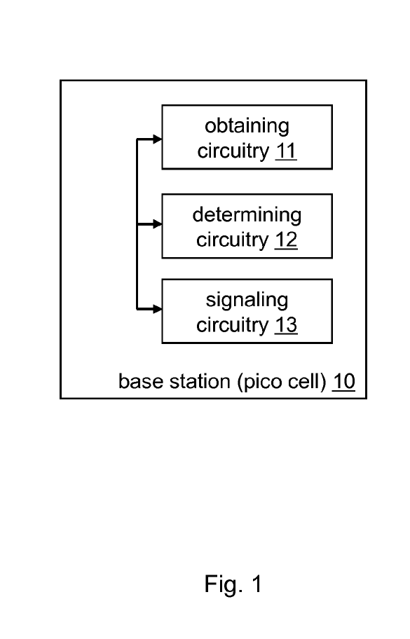

FIG. 1 is a block diagram illustrating an apparatus (in a first cell encompassed by a second cell in a heterogeneous network scenario) according to exemplary embodiments of the present invention. The apparatus may be an access node 10 such as a base station (serving a pico cell) comprising an obtaining circuitry 11, a determining circuitry 12, and a signaling circuitry 13. The obtaining circuitry 11 obtains an upper limit value for a network configuration parameter. The determining circuitry 12 determines said network configuration parameter for said first cell on the basis of performance data of said first cell and said upper limit value such that said network configuration parameter does not exceed said upper limit value. The signaling circuitry 13 signals said network configuration parameter for said first cell.

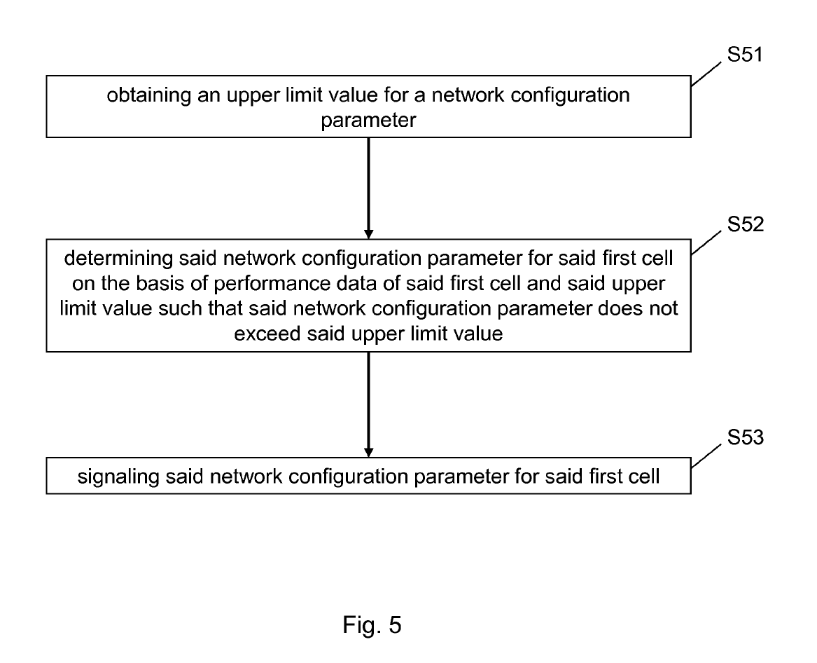

FIG. 5 is a schematic diagram of a procedure (in a first cell encompassed by a second cell in a heterogeneous network scenario) according to exemplary embodiments of the present invention. The apparatus according to FIG. 1 may perform the method of FIG. 5 but is not limited to this method. The method of FIG. 5 may be performed by the apparatus of FIG. 1 but is not limited to being performed by this apparatus.

As shown in FIG. 5, a procedure according to exemplary embodiments of the present invention comprises an operation of obtaining (S51) an upper limit value for a network configuration parameter (e.g. P₀_{_}_{Limit} as used below), an operation of determining (S52) said network configuration parameter for said first cell (e.g. P₀ₚ as used below, preferably a power control base level for said first cell) on the basis of performance data of said first cell (e.g. represented by P₀ₘₐₓ_{_}ᵢₙₜ as used below) and said upper limit value such that said network configuration parameter does not exceed said upper limit value, and an operation of signaling (S53) said network configuration parameter for said first cell.

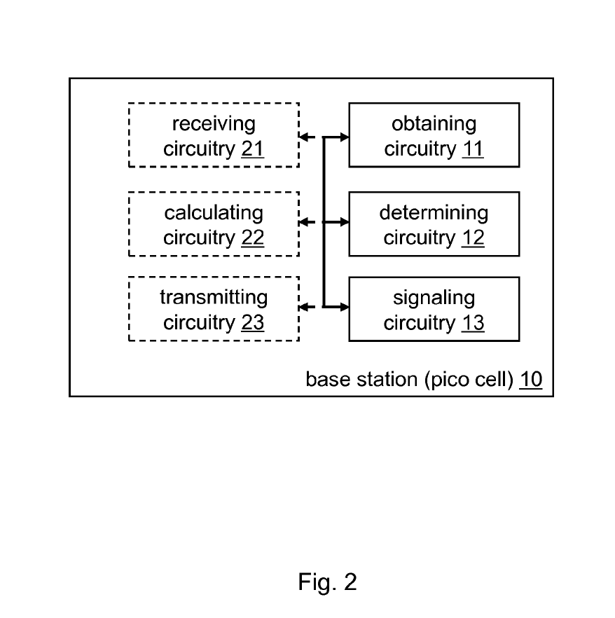

FIG. 2 is a block diagram illustrating an apparatus according to exemplary embodiments of the present invention. In particular, FIG. 2 illustrates a variation of the apparatus shown in FIG. 1. The apparatus according to FIG. 2 may thus further comprise a receiving circuitry 21, a calculating circuitry 22, and/or a transmitting circuitry 23.

According to exemplary embodiments of the present invention, at least some of the functionalities of the apparatus shown in FIG. 1 (or 2) may be shared between two physically separate devices forming one operational entity. Therefore, the apparatus may be seen to depict the operational entity comprising one or more physically separate devices for executing at least some of the described processes.

According to a variation of the procedure shown in FIG. 5, exemplary details of the obtaining operation (S51) are given, which are inherently independent from each other as such.

Such exemplary obtaining operation (S51) according to exemplary embodiments of the present invention may comprise an operation of receiving properties of said second cell, and an operation of calculating said upper limit value on the basis of said properties of said second cell.

According to further exemplary embodiments of the present invention, said properties of said second cell include at least one of a power control base level of said second cell (e.g. P₀ₘ as used below), a transmission power of said second cell (e.g. TXPₘ as used below), a path-loss compensation factor of said second cell (e.g. αₘ as used below), and a maximum path-loss of said second cell (e.g. Lₘₐₓ (L_{max,m}) as used below).

According to further exemplary embodiments of the present invention, said properties of said second cell include at least one of a maximum allowed interference power by a terminal served by said first cell allowed by said second cell (e.g. P_{Rx,min} as used below), and a difference value (e.g. Δ as used below) between a transmission power of said second cell and a transmission power of said first cell (e.g. TXPₚ as used below).

According to still further exemplary embodiments of the present invention, said properties of said second cell are received via at least one of an exchange via an X2 interface between said first cell and said second cell, an exchange of AS-config data via handover preparation information, delivery from an operation and maintenance entity based on an request, and delivery via an overload indicator procedure. Here, it is noted that the handover preparation (i.e. the AS-config data via handover preparation information) and the overload indicator are (usually) exchanged via the X2 interface. Accordingly, these may be seen as sub-options of the exchange via the X2 interface between said first cell and said second cell. Nevertheless, it is not excluded that these two proposed exchanges are effected via a different interface.

According to a variation of the procedure shown in FIG. 5, exemplary details of the obtaining operation (S51) are given, which are inherently independent from each other as such.

Such exemplary obtaining operation (S51) according to exemplary embodiments of the present invention may comprise an operation of transmitting properties of said first cell, and an operation of receiving said upper limit value.

According to further exemplary embodiments of the present invention, said properties of said first cell include at least one of a transmission power of said first cell, a path-loss compensation factor of said first cell (e.g. αₚ as used below), and a path-loss from a shortest distance between a cell edge of said first cell and a serving base station of said second cell (e.g. L as used below).

According to further exemplary embodiments of the present invention, said properties of said first cell are transmitted via at least one of an exchange via an X2 interface between said first cell and said second cell, an exchange of AS-config data via handover preparation information, and delivery to an operation and maintenance entity based on an request.

According to further exemplary embodiments of the present invention, said upper limit value is received via an X2 interface between said first cell and said second cell.

According to a variation of the procedure shown in FIG. 5, exemplary details of the obtaining operation (S51) are given, which are inherently independent from each other as such.

Such exemplary obtaining operation (S51) according to exemplary embodiments of the present invention may comprise an operation of receiving said upper limit value.

According to still further exemplary embodiments of the present invention, said first cell is a pico cell in said heterogeneous network scenario and the method is operable at or by a base station or access node of said pico cell. The second cell may be a macro cell in said heterogeneous network scenario.

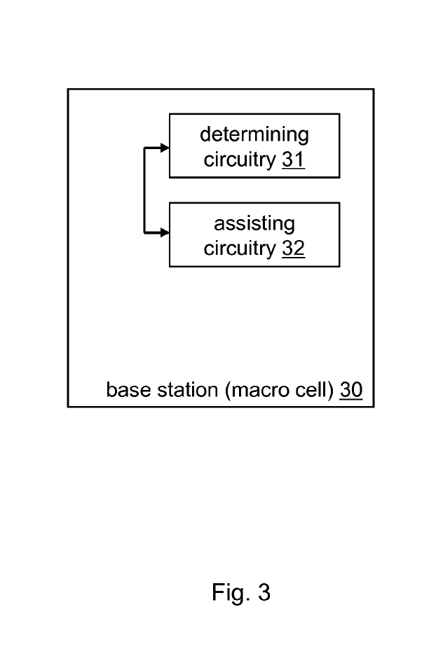

FIG. 3 is a block diagram illustrating an apparatus (in a second cell encompassing a first cell in a heterogeneous network scenario) according to exemplary embodiments of the present invention. The apparatus may be an access node 30 such as a base station (serving a macro cell) comprising a determining circuitry 31, and an assisting circuitry 32. The determining circuitry 31 determines properties of said second cell. The assisting circuitry 32 assists determination of a network configuration parameter for said first cell by an obtained upper limit value for said network configuration parameter on the basis of said properties of said second cell.

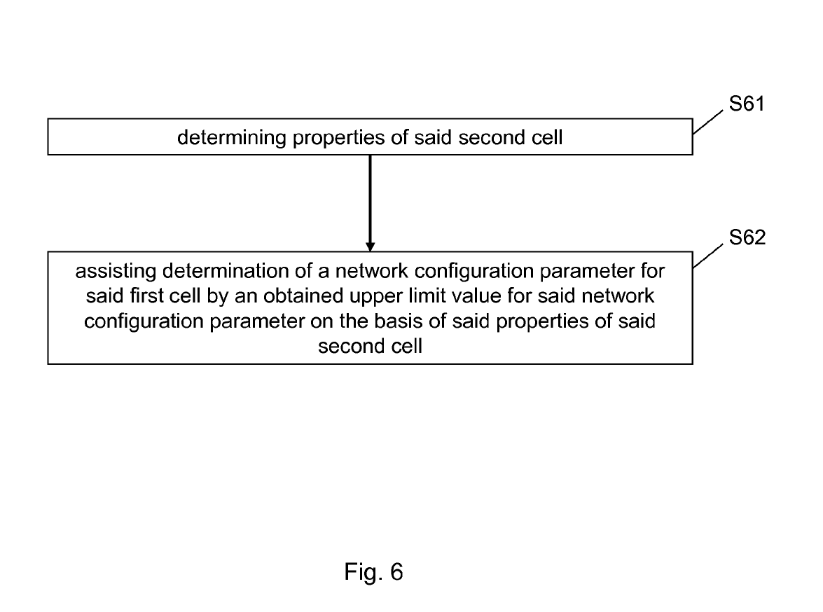

FIG. 6 is a schematic diagram of a procedure (in a second cell encompassing a first cell in a heterogeneous network scenario) according to exemplary embodiments of the present invention. The apparatus according to FIG. 3 may perform the method of FIG. 6 but is not limited to this method. The method of FIG. 6 may be performed by the apparatus of FIG. 3 but is not limited to being performed by this apparatus.

As shown in FIG. 6, a procedure according to exemplary embodiments of the present invention comprises an operation of determining (S61) properties of said second cell, and an operation of assisting (S62) determination of a network configuration parameter for said first cell by an obtained upper limit value for said network configuration parameter on the basis of said properties of said second cell.

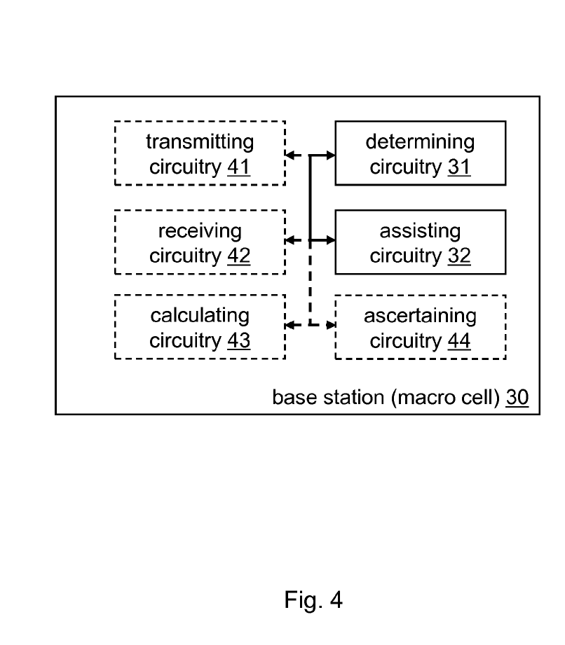

FIG. 4 is a block diagram illustrating an apparatus according to exemplary embodiments of the present invention. In particular, FIG. 4 illustrates a variation of the apparatus shown in FIG. 3. The apparatus according to FIG. 4 may thus further comprise a transmitting circuitry 41, a receiving circuitry 42, a calculating circuitry 43, and/or an ascertaining circuitry 44.

According to exemplary embodiments of the present invention, at least some of the functionalities of the apparatus shown in FIG. 3 (or 4) may be shared between two physically separate devices forming one operational entity. Therefore, the apparatus may be seen to depict the operational entity comprising one or more physically separate devices for executing at least some of the described processes.

According to a variation of the procedure shown in FIG. 6, exemplary details of the assisting operation (S62) are given, which are inherently independent from each other as such.

Such exemplary assisting operation (S62) according to exemplary embodiments of the present invention may comprise an operation of transmitting said properties of said second cell. Said upper limit value may be calculated (e.g. at a receiver of said properties, e.g. at a base station serving the first cell) on the basis of said properties of said second cell.

According to further exemplary embodiments of the present invention, said properties of said second cell include at least one of a power control base level of said second cell, a transmission power of said second cell, a path-loss compensation factor of said second cell, and a maximum path-loss of said second cell.

According to further exemplary embodiments of the present invention, said properties of said second cell include at least one of a maximum allowed interference power by a terminal served by said first cell allowed by said second cell, and a difference value between a transmission power of said second cell and a transmission power of said first cell.

According to still further exemplary embodiments of the present invention, said properties of said second cell are transmitted via at least one of an exchange via an X2 interface between said first cell and said second cell, an exchange of AS-config data via handover preparation information, delivery to an operation and maintenance entity based on an request, and delivery via an overload indicator procedure.

According to a variation of the procedure shown in FIG. 6, exemplary details of the assisting operation (S62) are given, which are inherently independent from each other as such.

Such exemplary assisting operation (S62) according to exemplary embodiments of the present invention may comprise an operation of receiving properties of said first cell, an operation of calculating said upper limit value on the basis of said properties of said first cell, and an operation of transmitting said upper limit value.

According to still further exemplary embodiments of the present invention, said properties of said first cell include at least one of a transmission power of said first cell, a path-loss compensation factor of said first cell, and a path-loss from a shortest distance between a cell edge of said first cell and a serving base station of said second cell.

According to still further exemplary embodiments of the present invention, said properties of said first cell are received via at least one of an exchange via an X2 interface between said first cell and said second cell, an exchange of AS-config data via handover preparation information, and delivery from an operation and maintenance entity based on an request.

According to still further exemplary embodiments of the present invention, said upper limit value is transmitted via an X2 interface between said first cell and said second cell.

According to a variation of the procedure shown in FIG. 6, exemplary details of the assisting operation (S62) are given, which are inherently independent from each other as such.

Such exemplary assisting operation (S62) according to exemplary embodiments of the present invention may comprise an operation of ascertaining a maximum path-loss of said second cell, and an operation of transmitting said maximum path-loss of said second cell.

According to still further exemplary embodiments of the present invention, said second cell is a macro cell in said heterogeneous network scenario and the method is operable at or by a base station or access node of said macro cell. Said first cell may be a pico cell in said heterogeneous network scenario.

In more specific terms, according to exemplary embodiments of the present invention, a method for automated cell-specific OLPC parameter setting is provided, where optimal setting of the small cell P₀ₚ in case of co-channel HetNet deployment results from cell-specific capping of a cell-and layer-individual P₀ maximization (P₀ₘₐₓ_{_}ᵢₙₜ) where only cell internal uplink relevant criteria as dynamic range are considered.

The capping according to exemplary embodiments of the present invention is given by a cell-specific P₀_{_}_{Limit}. which results from the HetNet properties. That is, a small cell is still free to adjust its P₀ autonomously, but it is not allowed to exceed a certain limit.

In other words, an optimal balancing of optimizing the small cell UE throughput without harming the macro UL throughput is provided according to exemplary embodiments of the present invention. According to these embodiments, the P₀ limitation (P₀_{_}_{Limit}) may depend on the most sensitive UE signal received at the macro base station which results from the farthest UE served by the macro cell, i.e. it depends on the M-UE served with path loss Lₘₐₓ.

The power limitation P₀ₚ of the considered small cell can be achieved with limiting the parameter to an upper bound according to following formulae:

P₀ₚ=min(P₀ₘₐₓ_{_}ᵢₙₜ, P₀_{_}_{Limit}) (2),

where

P₀_{_}_{Limit}=P₀ₘ+αₚ*Δ−(1−αₘ)*Lₘₐₓ+(1−αₚ)*L (3).

The above equations (2) and (3) are derived from FIG. 11.

According to exemplary embodiments of the present invention, P₀ₘₐₓ_{_}ᵢₙₜ can be determined by an eNB internal SON algorithm and optimizes the OLPC parameters on eNB internal performance data. For instance, the aforementioned simple and egoistic approach can be used just looking at dynamic range and power headrooms.

The determination of P₀_{_}_{Limit} requires input from the covering macro cell. P₀_{_}_{Limit} depends on the path loss Lₘₐₓ in the macro cell and its P₀ value (P₀ₘ).

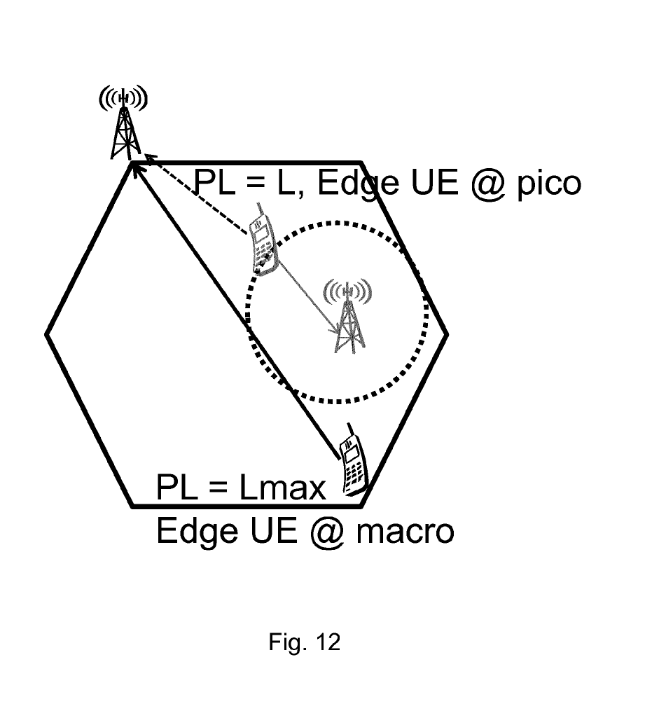

Furthermore, Δ is the difference TXPₘ−TXPₚ (i.e. the difference between transmission power in the macro cell and the transmission power in the pico (small) cell), and L is the path loss of cell edge P-UE towards macro base station, that is, the path loss on the shortest path from the pico cell edge to the base station serving the macro cell. FIG. 12 is a schematic diagram illustrating determination of the latter cell specific parameters. The capping expressed by the “min( )” ensures that the received power (received at the macro BS) from M-UE will not be less than interference power from pico UE (P-UE) of the considered pico base station.

According to exemplary embodiments, the method is implemented either as functionality operating centralized in the OAM layer or distributed in the eNBs. Calculation of P₀ₘₐₓ_{_}ᵢₙₜ is carried out eNB internally.

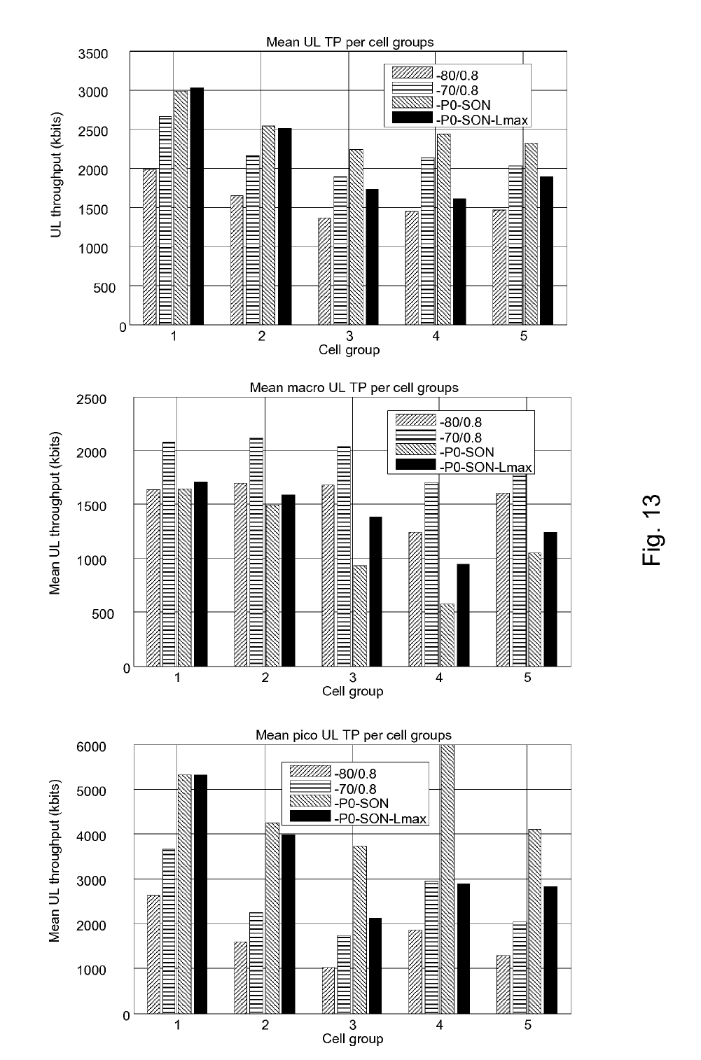

FIG. 13 shows diagrams illustrating simulation results for the exemplary HetNet deployment of FIG. 9 including results according to exemplary embodiments of the present invention.

In particular, FIG. 13 shows the P₀ optimization results in macro small cell scenario with and without pico cell specific power limitation. Namely, the two rightmost bars of each series illustrates reference results using network-wide fixed setting (80/0.8; 70/0.8).

Further, the third bar of each series shows how pico UE throughput is increased (lower diagram of FIG. 13) significantly compared to the reference results. At the same time, macro performance (middle diagram of FIG. 13) is sacrificed especially for cell group 4, in which the macro UEs are mostly at the cell border.

When pico cell maximum P₀ value is capped according to exemplary embodiments of the present invention (fourth/right bar of each series) by the provided Lₘₐₓ algorithm, the macro cell performance is better at the expense of pico UE performance. However, in cell groups 1 and 2, where pico UEs are not interfering macro UEs because they have higher path loss towards macro cell than macro UEs, the limitation has only minor impact. The Lₘₐₓ algorithm according to exemplary embodiments of the present invention is therefore limiting the pico P₀ only when necessary.

In the following, exemplary embodiments of the present invention are described in even more detail.

According to such exemplary embodiments of the present invention, the optimization is “distributed” with P₀_{_}_{Limit} being calculated in the small (pico) cell eNB.

Here, the the small cell which has to limit its P₀ takes care and calculate the P₀_{_}_{Limit} value. For that, the macro cell settings and properties like P₀ₘ, TXPₘ, αₘ and Lₘₐₓ, are provided or are made accessible to pico cell.

According to some of these exemplary embodiments of the present invention, obtaining these information/properties/parameters is effected as follows:
the information/properties/parameters may be exchanged via X2 interface (this would, for instance, require enhancement of the eNB configuration update message),
the information/properties/parameters may be derived from AS-Config data exchanged with handover preparation information, or
the information/properties/parameters may be requested (and delivered) from operation and maintenance (OAM) entity.

According to further exemplary embodiments of the present invention, the optimization is “distributed” with P₀_{_}_{Limit} being calculated in macro eNB and informed to the small cells.

Here, if P₀_{_}_{Limit} calculation is carried out in the macro base station, the macro BS calculates all P₀_{_}_{Limit} values for all small (e.g. pico) cells covered by the macro cell and requires from each small cell the following data: TXPₚ, L, as well as αₚ. After calculation, macro eNB informs the small cells about the P₀_{_}_{Limit} it has to use. This realization would have the largest standardization impact.

According to some of these exemplary embodiments of the present invention, obtaining these information/properties/parameters for P₀_{_}_{Limit} calculation is effected as follows:
the information/properties/parameters may be exchanged via X2 interface (this would require a new message to retrieve eNB configuration data from small cell),
the information/properties/parameters may be derived from AS-Config data exchanged with handover preparation information, or
the information/properties/parameters may be requested (and delivered) from OAM entity.

According to some of theses exemplary embodiments of the present invention, after the calculation, the macro eNB informs via X2 signaling the small cells with the dedicated P₀_{_}_{Limit} value.

According to further exemplary embodiments of the present invention, the optimization is “centralized” with P₀_{_}_{Limit} calculation in OAM (entity).

Here, in case of a centralized approach, e.g. on OAM side, all information from both layers pico (cell) and macro (cell) are collected and evaluated. This also requires a common OAM for both layers.

In so doing, the OAM is aware of all cell specific configuration (CM) data with exception of the Lₘₐₓ value. This value is determined by the macro base station by evaluation of UE measurements reports and is reported by the (macro) eNB.

According to some of these exemplary embodiments, after calculation, cell-specific P₀_{_}_{Limit} are sent as CM data to the small cell eNBs.

According to still further exemplary embodiments of the present invention, the optimization is “distributed” with modified P₀_{_}_{Limit} calculation in small cell eNB.

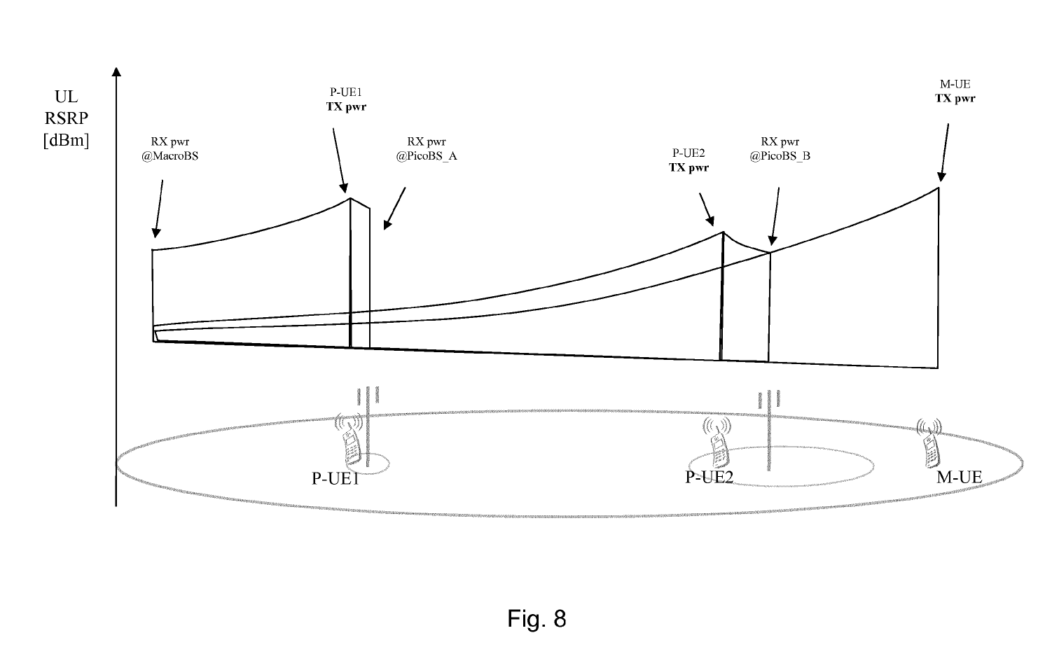

Namely, in line with FIG. 8, it can be assumed that the macro cell receives its farthest UE with the power density P_{Rx,min}.

With the assumptions above the following can be expressed:

P_{Rx,min}=P₀ₘ+αₘ*Lₘₐₓ−Lₘₐₓ (4)

Similar to the above it is again required that a pico UE shall not interfere a macro UE with more than P_{Rx,min}.

This leads to the following equation:

P₀ₚ+αₚ*(L−Δ)−L<P_{Rx,min} (5)

Furthermore, it is assume that the pico cell can determine the path loss of the edge UEs to itself Lₚ=L−Δ easier than the path loss of the edge UEs to the macro cell base station). Accordingly, equation (5) can be rewritten to read

P₀ₚ+αₚ*Lₚ−(Lₚ+Δ)<P_{Rx,min} (6)

which in turn can be rewritten to read

P₀ₚ<P_{Rx,min}+Δ−(1−αₚ)*Lₚ (7).

That is, according to these still further exemplary embodiments of the present invention, by using the substitution (4), a solution similar to a solution discussed above is achieved.

These still further exemplary embodiments of the present invention achieve the following advantages:
P_{Rx,min} is a very intuitive parameter for the macro eNB; it can be easily specified, and it can be easy determined,
P_{Rx,min} is not necessarily the received power of the farthest user, but a maximum allowed interference power by a pico UE; this gives more degree of freedom to the macro eNB (for instance, the requirement may be formulated tighter (i.e. a lower value), or less tight (i.e. larger value)),
knowledge of the macro power control parameters and the maximum path loss is not needed, and
the pico cell (BS) no longer needs to measure/estimate the path loss L between the its edge UEs and the macro cell, but it can measure more easily the path loss Lp between its edge UEs and its own cell.

Although Δ still has to be known, this is supposed to be a very static parameter which can be provided via OAM, or it can be read from X2 signaling such as AS-config (see above).

Instead of P_{Rx,min}, according to some of the exemplary embodiments of the present invention, the macro eNB may also send the current Interference over Thermal (IoT) to the pico cell. This would also provide useful information to the pico cell. The pico cell then can take care that its UEs does not (significantly) increase the macro IoT by appropriate configuration of power control parameters, using the same equations as above. Accordingly, the provided IoT may be understood as indicative of the maximum allowed interference power mentioned above. The IoT has the advantage that this value is already available at the macro eNB, and is well specified.

According to still further embodiments of the present invention, a heterogeneous network with macro cells and small cells (e.g. pico cells) is provided, where the UEs determine their transmit power based on parameters signalled by the base station. The small cell has an upper limit for one of the parameters and configures this parameter autonomously as long as it does not exceed this upper limit.

The upper limit may be provided by network management or domain management (“OAM”).

The upper limit may be provided by the macro base station via the X2 interface.

The macro base station may decide the upper limit based on further parameter provided by the small cell via X2.

The provided parameters may be at least one of P₀ used in the pico cell and alpha used in the pico cell.

The upper limit may be determines inside the pico cell based on information provided by the macro via X2 interface.

The information provided by the macro cell may be a maximum allowed power received by a UE connected to the pico cell (BS).

The information provided by the macro cell may be the current Interference over Thermal (IoT).

The information provided by the macro cell may contain a worst case path loss (e.g. Lₘₐₓ).

The information provided by the macro cell may use the eNB configuration update message (for provision/transmission).

The information provided by the macro cell may use the Overload Indicator procedure (for provision/transmission). Here, according to the OI procedure, a cell can already signal interference thresholds to a neighbour. The purpose is to make the neighbour indicate where the interference is larger than a certain value. Although the purpose is to be redefined, this is a much simpler process in 3GPP, since an existing message can be used, and only the stage 2 description (and not stage 3 description) thereof is to be modified.

The above-described procedures and functions may be implemented by respective functional elements, processors, or the like, as described below.

In the foregoing exemplary description of the network entity, only the units that are relevant for understanding the principles of the invention have been described using functional blocks. The network entity may comprise further units that are necessary for its respective operation. However, a description of these units is omitted in this specification. The arrangement of the functional blocks of the devices is not construed to limit the invention, and the functions may be performed by one block or further split into sub-blocks.

When in the foregoing description it is stated that the apparatus, i.e. network entity (or some other means) is configured to perform some function, this is to be construed to be equivalent to a description stating that a (i.e. at least one) processor or corresponding circuitry, potentially in cooperation with computer program code stored in the memory of the respective apparatus, is configured to cause the apparatus to perform at least the thus mentioned function. Also, such function is to be construed to be equivalently implementable by specifically configured circuitry or means for performing the respective function (i.e. the expression “unit configured to” is construed to be equivalent to an expression such as “means for”).

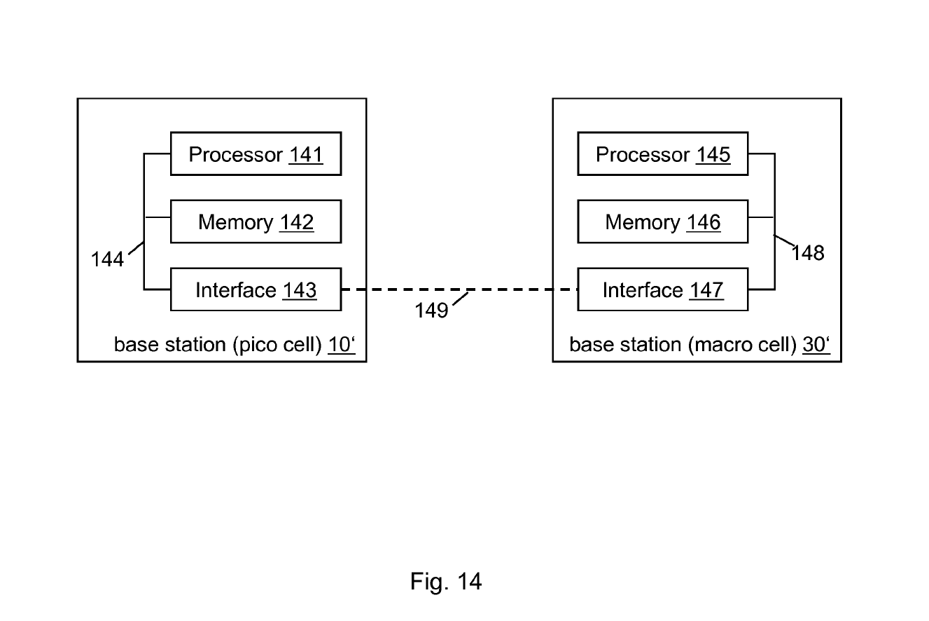

In FIG. 14, an alternative illustration of apparatuses according to exemplary embodiments of the present invention is depicted. As indicated in FIG. 14, according to exemplary embodiments of the present invention, the apparatus (base station) 10′ (corresponding to the base station 10) comprises a processor 141, a memory 142 and an interface 143, which are connected by a bus 144 or the like. Further, according to exemplary embodiments of the present invention, the apparatus (base station) 30′ (corresponding to the base station 30) comprises a processor 145, a memory 146 and an interface 147, which are connected by a bus 148 or the like, and the apparatuses may be connected via link 149, respectively.

The processor 141/145 and/or the interface 143/147 may also include a modem or the like to facilitate communication over a (hardwire or wireless) link, respectively. The interface 143/147 may include a suitable transceiver coupled to one or more antennas or communication means for (hardwire or wireless) communications with the linked or connected device(s), respectively. The interface 143/147 is generally configured to communicate with at least one other apparatus, i.e. the interface thereof.

The memory 142/146 may store respective programs assumed to include program instructions or computer program code that, when executed by the respective processor, enables the respective electronic device or apparatus to operate in accordance with the exemplary embodiments of the present invention.

In general terms, the respective devices/apparatuses (and/or parts thereof) may represent means for performing respective operations and/or exhibiting respective functionalities, and/or the respective devices (and/or parts thereof) may have functions for performing respective operations and/or exhibiting respective functionalities.

When in the subsequent description it is stated that the processor (or some other means) is configured to perform some function, this is to be construed to be equivalent to a description stating that at least one processor, potentially in cooperation with computer program code stored in the memory of the respective apparatus, is configured to cause the apparatus to perform at least the thus mentioned function. Also, such function is to be construed to be equivalently implementable by specifically configured means for performing the respective function (i.e. the expression “processor configured to [cause the apparatus to] perform xxx-ing” is construed to be equivalent to an expression such as “means for xxx-ing”).

According to exemplary embodiments of the present invention, an apparatus representing the base station 10 comprises at least one processor 141, at least one memory 142 including computer program code, and at least one interface 143 configured for communication with at least another apparatus. The processor (i.e. the at least one processor 141, with the at least one memory 142 and the computer program code) is configured to perform obtaining an upper limit value for a network configuration parameter (thus the apparatus comprising corresponding means for obtaining), to perform determining said network configuration parameter for said first cell on the basis of performance data of said first cell and said upper limit value such that said network configuration parameter does not exceed said upper limit value (thus the apparatus comprising corresponding means for determining), and to perform signaling said network configuration parameter for said first cell (thus the apparatus comprising corresponding means for signaling).

Further, according to exemplary embodiments of the present invention, an apparatus representing the base station 30 comprises at least one processor 145, at least one memory 146 including computer program code, and at least one interface 147 configured for communication with at least another apparatus. The processor (i.e. the at least one processor 145, with the at least one memory 146 and the computer program code) is configured to perform determining properties of said second cell (thus the apparatus comprising corresponding means for determining), and to perform assisting determination of a network configuration parameter for said first cell by an obtained upper limit value for said network configuration parameter on the basis of said properties of said second cell (thus the apparatus comprising corresponding means for signaling).

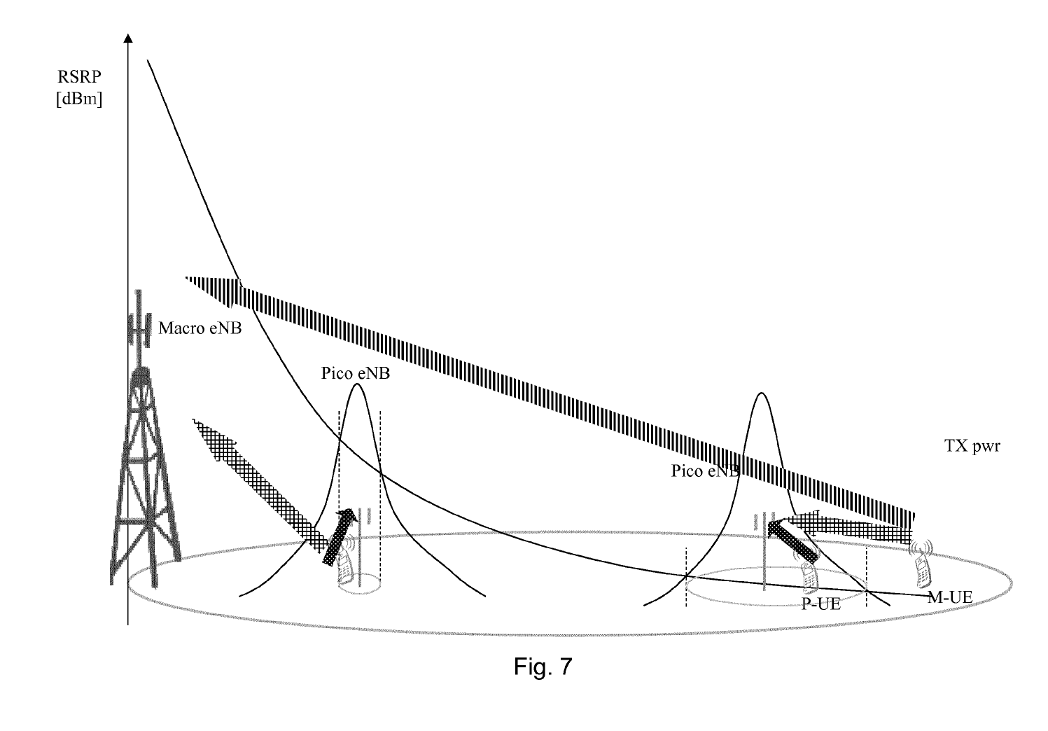

For further details regarding the operability/functionality of the individual apparatuses, reference is made to the above description in connection with any one of FIGS. 1 to 13, respectively.

For the purpose of the present invention as described herein above, it should be noted that

method steps likely to be implemented as software code portions and being run using a processor at a network server or network entity (as examples of devices, apparatuses and/or modules thereof, or as examples of entities including apparatuses and/or modules therefore), are software code independent and can be specified using any known or future developed programming language as long as the functionality defined by the method steps is preserved;

generally, any method step is suitable to be implemented as software or by hardware without changing the idea of the embodiments and its modification in terms of the functionality implemented;

method steps and/or devices, units or means likely to be implemented as hardware components at the above-defined apparatuses, or any module(s) thereof, (e.g., devices carrying out the functions of the apparatuses according to the embodiments as described above) are hardware independent and can be implemented using any known or future developed hardware technology or any hybrids of these, such as MOS (Metal Oxide Semiconductor), CMOS (Complementary MOS), BiMOS (Bipolar MOS), BiCMOS (Bipolar CMOS), ECL (Emitter Coupled Logic), TTL (Transistor-Transistor Logic), etc., using for example ASIC (Application Specific IC (Integrated Circuit)) components, FPGA (Field-programmable Gate Arrays) components, CPLD (Complex Programmable Logic Device) components or DSP (Digital Signal Processor) components;

devices, units or means (e.g. the above-defined network entity or network register, or any one of their respective units/means) can be implemented as individual devices, units or means, but this does not exclude that they are implemented in a distributed fashion throughout the system, as long as the functionality of the device, unit or means is preserved;

an apparatus like the user equipment and the network entity/network register may be represented by a semiconductor chip, a chipset, or a (hardware) module comprising such chip or chipset; this, however, does not exclude the possibility that a functionality of an apparatus or module, instead of being hardware implemented, be implemented as software in a (software) module such as a computer program or a computer program product comprising executable software code portions for execution/being run on a processor;

a device may be regarded as an apparatus or as an assembly of more than one apparatus, whether functionally in cooperation with each other or functionally independently of each other but in a same device housing, for example.

In general, it is to be noted that respective functional blocks or elements according to above-described aspects can be implemented by any known means, either in hardware and/or software, respectively, if it is only adapted to perform the described functions of the respective parts. The mentioned method steps can be realized in individual functional blocks or by individual devices, or one or more of the method steps can be realized in a single functional block or by a single device.

Generally, any method step is suitable to be implemented as software or by hardware without changing the idea of the present invention. Devices and means can be implemented as individual devices, but this does not exclude that they are implemented in a distributed fashion throughout the system, as long as the functionality of the device is preserved. Such and similar principles are to be considered as known to a skilled person.

Software in the sense of the present description comprises software code as such comprising code means or portions or a computer program or a computer program product for performing the respective functions, as well as software (or a computer program or a computer program product) embodied on a tangible medium such as a computer-readable (storage) medium having stored thereon a respective data structure or code means/portions or embodied in a signal or in a chip, potentially during processing thereof.

The present invention also covers any conceivable combination of method steps and operations described above, and any conceivable combination of nodes, apparatuses, modules or elements described above, as long as the above-described concepts of methodology and structural arrangement are applicable.

In view of the above, there are provided measures for uplink power control in heterogeneous network scenarios. Such measures exemplarily comprise obtaining an upper limit value for a network configuration parameter, determining said network configuration parameter for said first cell on the basis of performance data of said first cell and said upper limit value such that said network configuration parameter does not exceed said upper limit value, and signaling said network configuration parameter for said first cell.

Even though the invention is described above with reference to the examples according to the accompanying drawings, it is to be understood that the invention is not restricted thereto. Rather, it is apparent to those skilled in the art that the present invention can be modified in many ways without departing from the scope of the inventive idea as disclosed herein.

List of Acronyms and Abbreviations

3GPP 3^{rd} Generation Partnership Project

AS access stratum

BS base station

DL downlink

eNB evolved NodeB, eNodeB

HetNet heterogeneous network

IoT Interference over Thermal

LTE Long Term Evolution

MBS macro base station, macroBS

M-UE macro-UE

OAM operation and maintenance

OLPC open loop power control

PBS pico base station, picoBS

PC power control

PHR power headroom

PL path loss, path-loss

PSD power spectral density

P-UE pico-UE

RRC radio resource control

SINR signal to interference and noise ratio

SON self optimizing network, self-organizing network

TX transmission

TXP transmission power

UE user equipment

UL uplink

1-9. (canceled)

10. A method in a second cell encompassing a first cell in a heterogeneous network scenario, the method comprising
determining properties of said second cell, and
assisting determination of a network configuration parameter for said first cell by an obtained upper limit value for said network configuration parameter on the basis of said properties of said second cell.

11. The method according to claim 10, wherein
in relation to said assisting, said method further comprises
transmitting said properties of said second cell, wherein
said upper limit value being calculated on the basis of said properties of said second cell.

12-18. (canceled)

19. An apparatus in a first cell encompassed by a second cell in a heterogeneous network scenario, the apparatus comprising
at least one processor,
at least one memory including computer program code, and
at least one interface configured for communication with at least another apparatus,
the at least one processor, with the at least one memory and the computer program code, being configured to cause the apparatus to perform:
obtaining an upper limit value for a network configuration parameter,

20. The apparatus according to claim 19, wherein
the at least one processor, with the at least one memory and the computer program code, being further configured to cause the apparatus to perform in relation to said obtaining:
receiving properties of said second cell, and
calculating said upper limit value on the basis of said properties of said second cell.

21. The apparatus according to claim 20, wherein
said properties of said second cell include at least one of a power control base level of said second cell, a transmission power of said second cell, a path-loss compensation factor of said second cell, and a maximum path-loss of said second cell, or wherein
said properties of said second cell include at least one of a maximum allowed interference power by a terminal served by said first cell allowed by said second cell, and a difference value between a transmission power of said second cell and a transmission power of said first cell.

22. The apparatus according to claim 20, wherein
said properties of said second cell are received via at least one of an exchange via an X2 interface between said first cell and said second cell, an exchange of AS-config data via handover preparation information, delivery from an operation and maintenance entity based on an request, and delivery via an overload indicator procedure.

23. The apparatus according to claim 19, wherein
the at least one processor, with the at least one memory and the computer program code, being further configured to cause the apparatus to perform in relation to said obtaining:
transmitting properties of said first cell, and
receiving said upper limit value.

24. The apparatus according to claim 23, wherein
said properties of said first cell include at least one of a transmission power of said first cell, a path-loss compensation factor of said first cell, and a path-loss from a shortest distance between a cell edge of said first cell and a serving base station of said second cell.

25. The apparatus according to claim 23, wherein
said properties of said first cell are transmitted via at least one of an exchange via an X2 interface between said first cell and said second cell, an exchange of AS-config data via handover preparation information, and delivery to an operation and maintenance entity based on an request, and/or
said upper limit value is received via an X2 interface between said first cell and said second cell.

26. The apparatus according to claim 19, wherein
the at least one processor, with the at least one memory and the computer program code, being further configured to cause the apparatus to perform in relation to said obtaining:
receiving said upper limit value.

27. The apparatus according to claim 19, wherein
the apparatus is operable as or at a base station or access node of a cellular system, and/or
the apparatus is operable in at least one of a LTE and a LTE-A cellular system, and/or
said first cell is a pico cell in said heterogeneous network scenario and the apparatus is operable as or at a base station or access node of said pico cell, and/or
said second cell is a macro cell in said heterogeneous network scenario.

28. An apparatus in a first cell encompassed by a second cell in a heterogeneous network scenario, the apparatus comprising
at least one processor,
at least one memory including computer program code, and
at least one interface configured for communication with at least another apparatus,
the at least one processor, with the at least one memory and the computer program code, being configured to cause the apparatus to perform:
determining properties of said second cell, and
assisting determination of a network configuration parameter for said first cell by an obtained upper limit value for said network configuration parameter on the basis of said properties of said second cell.

29. The apparatus according to claim 28, wherein
the at least one processor, with the at least one memory and the computer program code, being further configured to cause the apparatus to perform in relation to said assisting:
transmitting said properties of said second cell, wherein
said upper limit value being calculated on the basis of said properties of said second cell.

30. The apparatus according to claim 29, wherein
said properties of said second cell include at least one of a power control base level of said second cell, a transmission power of said second cell, a path-loss compensation factor of said second cell, and a maximum path-loss of said second cell, or wherein
said properties of said second cell include at least one of a maximum allowed interference power by a terminal served by said first cell allowed by said second cell, and a difference value between a transmission power of said second cell and a transmission power of said first cell.

31. The apparatus according to claim 29, wherein
said properties of said second cell are transmitted via at least one of an exchange via an X2 interface between said first cell and said second cell, an exchange of AS-config data via handover preparation information, delivery to an operation and maintenance entity based on an request, and delivery via an overload indicator procedure.

32. The apparatus according to claim 28, wherein
the at least one processor, with the at least one memory and the computer program code, being further configured to cause the apparatus to perform in relation to said assisting:
receiving properties of said first cell,
calculating said upper limit value on the basis of said properties of said first cell, and
transmitting said upper limit value.

33. The apparatus according to claim 32, wherein
said properties of said first cell include at least one of a transmission power of said first cell, a path-loss compensation factor of said first cell, and a path-loss from a shortest distance between a cell edge of said first cell and a serving base station of said second cell.

34. The apparatus according to claim 32, wherein
said properties of said first cell are received via at least one of an exchange via an X2 interface between said first cell and said second cell, an exchange of AS-config data via handover preparation information, and delivery from an operation and maintenance entity based on an request, and/or
said upper limit value is transmitted via an X2 interface between said first cell and said second cell.

35. The apparatus according to claim 28, wherein
the at least one processor, with the at least one memory and the computer program code, being further configured to cause the apparatus to perform in relation to said assisting:
ascertaining a maximum path-loss of said second cell, and
transmitting said maximum path-loss of said second cell.

36. The apparatus according to claim 28, wherein
the apparatus is operable as or at a base station or access node of a cellular system, and/or
the apparatus is operable in at least one of a LTE and a LTE-A cellular system, and/or
said first cell is a pico cell in said heterogeneous network scenario, and/or
said second cell is a macro cell in said heterogeneous network scenario and the apparatus is operable as or at a base station or access node of said macro cell.

37-41. (canceled)
